(19) United States
(12) Patent Application Publication
(10) Pub. No.: US 2021/0155764 A1
(43) Pub. Date: May 27, 2021

(54) GELATIN-BASED NANOFIBROUS NON-WOVEN MATERIAL

(71) Applicant: Gelatex Technologies OÜ, Tallinn (EE)

(72) Inventors: Märt-Erik Martens, Tallinn (EE); Mihkel Ilisson, Tartu (EE); Tõnis Laasfeld, Tartu (EE); Jörgen Metsik, Tallinn (EE); Uno Mäeorg, Tartu (EE)

(73) Assignee: Gelatex Technologies OÜ, Tallinn (EE)

(21) Appl. No.: 17/104,314

(22) Filed: Nov. 25, 2020

Related U.S. Application Data
(60) Provisional application No. 62/941,168, filed on Nov. 27, 2019.

(51) Int. Cl. C08J 3/24; C08J 5/00; B32B 5/02; B32B 5/26

(52) U.S. Cl. CPC C08J 3/243; C08J 5/005; B32B 5/024; B32B 5/022; B32B 5/26; B32B 2262/062; C08J 2383/04; C08J 2483/04; C08J 2375/04; C08J 2475/04; C08J 2489/04; C08J 2389/04

(57) ABSTRACT

Disclosed is a method for producing a nanofibrous non-woven material and a nanofibrous non-woven material with cross-linked gelatin nanofibers. The method includes producing gelatin nanofibers; producing a nanofibrous material using the produced gelatin nanofibers; and treating the nanofibrous material by a crosslinking agent for forming adhesion bonds in the nanofibrous material and to obtain the nanofibrous non-woven material.

### TECHNICAL FIELD

The present disclosure relates generally to biodegradable and eco-friendly nanofibrous materials; and more specifically, to methods for producing nanofibrous non-woven material, nanofibrous non-woven materials and products produced thereof.

### BACKGROUND

As long as people eat meat, there are animal leftovers that should be used, but unfortunately even now so much of is not. In fact, just in the EU over 5 million tons of animal waste is simply burnt. So it makes sense to use that but it should be just used without creating pollution. However, from 2 billion square meters of leather produced every year in the world 95% is made using toxic chemicals that cause cancer and pollute waters. Even if eco-friendly alternatives to it exist, all those solutions are just too slow to produce, expensive and therefore not suitable for mass-production. In order to make a change, eco-friendly materials need to be accessible and affordable to everyone. However, there was still an unmet demand for materials that would at the same time be eco-friendly, affordable and easily scalable.

Conventionally, animal hides and natural fibers such as cotton or silk have been processed and used as textiles, packaging materials and for aesthetic purposes. However, the processing of animal hides to produce leather has been a major cause of environmental pollution, wildlife endangerment and several ethical concerns. With advancements in technology, synthetic fibers such as polyester and nylon have become widely popular as such synthetic fibers are easy to manufacture on a large scale. However, such synthetic fibers pose ecological concerns as such fibers are manufactured using non-renewable resources and are non-biodegradable.

In recent times, gelatin and non-woven materials produced therefrom have emerged as a promising bio-degradable material for fabric production and applications in pharmaceuticals, food industry and medical applications. Gelatin is a protein that is produced by irreversible hydrolysis of collagen. Collagen itself is an abundant protein in connective tissues, making up about one third of the total protein content in mammalian organisms. Collagen and gelatin can be both considered as residual products while they are produced during the recycling process of organic waste received from animals (e.g. bones, skin and other low-value parts). Although non-woven materials produced from gelatin possess high surface area and high porosity, such materials have poor mechanical properties and cannot be employed for applications requiring durability and strength of the material. Furthermore, non-woven materials produced from gelatin have high moisture absorption and moisture retention properties. There are known methods to produce nanofibers from gelatin—electrospinning, drawing, blow-spinning, thermal-induced phase separation, template synthesis. Gelatin nanofibers are produced as a non-woven material. The non-woven materials produced from known techniques are not durable.

There is a vast problem in textile industry as majority of fibers are produced from synthetic polymers similarly to leather replacement products. Most of these synthetic polymers are made from crude oil that is non-renewable resource. There is a lack of materials that are made from renewable resources that could be produced in large scale.

Gelatin is a substance derived from the low-valued waste of livestock industry by-products. There is still a lot of this waste that is just burnt that could be turned to gelatin. Gelatin can be easily turned into nanofibers with a variety of methods such as electrospinning, thermal-induced phase separation, drawing etc. Non-woven material that is made from these fibers possess high surface area and high porosity but has poor mechanical properties.

Therefore, in light of the foregoing discussion, there exists a need to overcome the aforementioned drawbacks associated with the production of non-woven materials from gelatin nanofibers.

### SUMMARY

The present disclosure seeks to provide a method for producing a nanofibrous non-woven material. The present disclosure also seeks to provide a nanofibrous non-woven material comprising cross-linked gelatin nanofibers. An aim of the present disclosure is to provide a solution that overcomes at least partially the problems encountered in prior art and to provide the solution for making leather-like material from gelatin.

In a first aspect, the present disclosure provides a method for producing a nanofibrous non-woven material, the method comprising producing gelatin nanofibers; producing a nanofibrous material using the produced gelatin nanofibers; and treating the nanofibrous material by a crosslinking agent for forming adhesion bonds in the nanofibrous material and to obtain the nanofibrous non-woven material.

In a second aspect, the present disclosure provides a nanofibrous non-woven material comprising cross-linked gelatin nanofibers.

In some aspects, the present disclosure teaches that nanofibrous material comprising gelatin nanofibers that can be cross-linked which interfibrous voids are partially filled with polymeric material like polysiloxane; can be cross-linked which interfibrous voids are partially filled with polymeric material like polymer derived from natural oil polymerization; can be cross-linked which interfibrous voids are partially filled with polymeric material like polyurethane. In some additional embodiments, the present disclosure teaches that laminated material comprising of material described above and the substrate that can be wood, cotton

Embodiments of the present disclosure substantially eliminate or at least partially address the aforementioned problems in the prior art, and enables high tensile strength, abrasion resistance and resistance to the environment in the nanofibrous non-woven material. The adhesion between the gelatin nanofibers is significantly improved using the crosslinking agent, thereby producing a material with high water-resistance and improved mechanical properties that is strong enough to be used in applications such as textile, fashion, interior design, automotive, packaging.

Fibers adhesion to each other needs to be improved to improve mechanical properties of gelatin-based non-woven material. This can be done by treatment with more durable polymers (0 to 40% w/w) such as two component silicone polymers, natural Latex, polyurethane polymers, natural oils (linseed oil, rapeseed oil, palm oil, olive oil) and with a mixture of these oils. In addition, this kind of treatment would add water resistance to the material without previous cross-linking.

Lamination with reinforcing layer can be carried out to achieve final strength of the material depending on the application. This can be done with different adhesives such as hot-melt glue, natural Latex, polyurethane based adhesives, thermo-reactive adhesives etc. Reinforcing layer can be stronger woven material.

The present disclosure provides material that is strong enough to be used in applications such as textile, fashion, interior design, automotive, packaging.

The embodiments according to the present disclosure enable to make gelatin-based nanofibrous material, make use of the abundant waste of leather and meat industries while at the same time solving the problem of mass-fashion and automotive brands not having eco-friendly materials available in mass-scale. As a result, the embodiments according to the present disclosure enable a material that is unique on its own, yet quite similar to leather or suede and suitable for similar applications.

The embodiments further enable the faster production and improve material durability, because gelatin fibers produced by known methods (e.g. electrospinned material) was too thin and production too slow, expensive and energy demanding. As a result, the embodiments of the present disclosure good for more than just making an eco-friendly material and enable to make nanofibrous materials faster than other current technologies. I.e. the material produced according to the present disclosure is an airy fibrous gelatin-based material that can be easily produced on an industrial scale and have potential applications in the textile industry, interior design, drug testing, dentistry, wound care or even filtration.

Filling the voids between fibers in gelatin nanofibrous mesh to enhance mechanical properties of the material enchases mechanical properties of the material. Other methods to enhance mechanical properties of the nanofibrous non-woven material are cross-linking with dangerous reactive chemicals. The embodiments enhance properties of the nanofibrous non-woven material and enable to use this material in textile, automotive, interior, fashion or packaging application.

Additional aspects, advantages, features and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. Embodiments of the present disclosure will now be described, by way of example only, with references to the following illustrations wherein:

FIG. 1 is a flow chart depicting steps of a method for producing a nanofibrous non-woven material, in accordance with an embodiment of the present disclosure;

FIG. 2A and FIG. 2B are scanning electron microscope (SEM) images of the nanofibrous non-woven material, in accordance with an embodiment of the present disclosure;

FIG. 3 illustrates an example of laminated material having different layers according to an embodiment of the preset disclosure;

FIG. 4 illustrates a schematic diagram of lamination to enhance mechanical properties of materials;

FIG. 5A, FIG. 5B and FIG. 5C are schematic illustrations of laminated nanofibrous non-woven materials, in accordance with various implementations of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Based on the physical and chemical properties of both fibers and the primary material, the following assumptions are considered for the development of after-treatment technologies: (i) As the single fibers of gelatin have high tensile strength and elastic modulus, the poor mechanical properties of the material are resulted from weak interactions between the fibers. Therefore, to improve mechanical properties of the material, it is advantageous to enhance interactions between the fibers using either physical or chemical methods. (ii) Considering the high hydrophilicity of gelatin fibers, it is beneficial to mask its polar functional groups either by chemical derivatization or physical coating with a hydrophobic agent in order to improve its water-resistant properties. (iii) The empty space between the fibers act as capillaries and therefore absorb water due to capillary forces. Therefore, it is useful to block them either completely or partially. All the mentioned drawbacks can be mitigated by either chemical or physical crosslinking methods.

Chemical crosslinking reagents are either monomeric or polymeric compounds which consists two or more reactive functional groups, e.g. amino (—NH2), hydroxyl (—OH), aldehyde (—CHO), isocyanate (—NCO), halide (—Cl, —Br, —I), epoxide, carbodiimide (—N═C═N—), hydride (—H), carboxylic acid derivatives (—COX, where X is activating group such as halogen (—F, —Cl, —Br, —I), vinyl (—CH═CH2), N-hydroxysuccinimidyl, 1-hydroxybenzotriazolyl or any other group, which corresponding acid HX, has water-phase pKa value lower than 14). These compounds are able to react with functional groups found in gelatin, e.g. hydroxyl (—OH), carboxyl (—COOH), amino (13 NH2), amide (—CONH2). Upon chemical crosslinking reaction, new covalent bonds form between the crosslinker and two different fibers. Chemical crosslinking reaction can be carried out in various conditions: temperature —80 . . . 250° C., pressure 0 . . . 100 bar, with the presence or absence of chemical catalyst, initiator or additional reagent (such as a base or acid) and with presence or absence of physical modifier (such as UV-light or microwave irradiation).

Physical crosslinking serves the same purpose as chemical crosslinking, two different approaches are available: (i) New covalent bonds between fiber and crosslinker are not formed. Rather, the crosslinker binds with the fiber by other interactions, such as dispersion, dipole-dipole, dipole-induced dipole forces and by hydrogen bonding. Crosslinker may be any polymer (polyethylene, polypropylene, polysiloxane, polyurethane, polyvinyl alcohol, polyvinyl acetate, polyethylene glycol, polyamide or any co-polymer) which can be incorporated into fibrous gelatin matrix. (ii) New covalent bonds between fibers are formed, but only a physical stimulus is used to form these. Such physical stimuli are e.g. electron beam irradiation, plasma treatment, thermal treatment.

In a first aspect, the present disclosure provides a method for producing a nanofibrous non-woven material, the method comprising producing gelatin nanofibers; producing a nanofibrous material using the produced gelatin nanofibers; and treating the nanofibrous material by a crosslinking agent for forming adhesion bonds in the nanofibrous material and to obtain the nanofibrous non-woven material.

In a second aspect, the present disclosure provides a nanofibrous non-woven material comprising cross-linked gelatin nanofibers. In another embodiment of the second aspect, the present disclosure provides a nanofibrous material comprising gelatin nanofibers that can be cross-linked which interfibrous voids are partially filled with polymeric material like polysiloxane. In another embodiment of the second aspect, the present disclosure provides a nanofibrous material comprising gelatin nanofibers that can be cross-linked which interfibrous voids are partially filled with polymeric material like polymer derived from natural oil polymerization. In another embodiment of the second aspect, the present disclosure provides a nanofibrous material comprising gelatin nanofibers that can be cross-linked which interfibrous voids are partially filled with polymeric material like polyurethane. In another embodiment, the present disclosure provides a laminated material comprising of material described above in the embodiments of the second aspect and the substrate that can be wood, cotton.

The present disclosure provides a method of producing nanofibrous non-woven material and a nanofibrous non-woven material comprising cross-linked gelatin nanofibers. The nanofibrous non-woven material produced using the method described herein has high tensile strength, abrasion resistance and resistance to the environment. Notably, the adhesion between the gelatin nanofibers is significantly improved using the crosslinking agent, thereby producing a material with high water-resistance and improved mechanical properties that is strong enough to be used in applications such as textile, fashion, interior design, automotive, packaging. Moreover, low-valued waste of livestock industry by-products that would otherwise be burnt and contribute to environmental pollution can be used to produce gelatin nanofibers. Furthermore, the method of the present disclosure is efficient, economically viable and can be scaled for mass-production. The present disclosure reduces abundant waste of leather and meat industries while at the same time solving the problem of mass-fashion and automotive brands not having eco-friendly materials available in mass-scale. The nanofibrous non-woven material provided herein has a texture similar to leather or suede and suitable for similar applications.

The method comprises producing gelatin nanofibers. Notably, gelatin is a protein that is produced by irreversible hydrolysis of collagen. Collagen is an abundant protein in connective tissues of animals, making up about one third of the total protein content in mammalian organisms. Collagen and gelatin can be both considered as residual products while they are produced during the recycling process of organic waste received from animals, for example bones, skin and other low-value parts. Subsequently, the gelatin obtained thereby is processed using techniques such as electrospinning, drawing, blow-spinning, thermal-induced phase separation, template synthesis to produce the gelatin nanofibers. Wet spinning is commonly used that involves the extrusion of a protein solution through a spinneret into an acid-salt coagulating bath, which usually contains aqueous ammonium sulfate, acetic acid, isopropanol, or acetone. Alternatively, dry spinning comprises extrusion into an evaporative atmosphere. It will be appreciated that gelatin is generally derived from low-valued waste of livestock industry by-products that are generally burnt leading to release of toxic pollutants into environment. Beneficially, use of such livestock industry by-products for production of gelatin thereby reduces environmental pollution and provides sustainable, bio-degradable nanofibers.

Optionally, a weighted average diameter of the gelatin nanofibers is 20 nm-2 μm. Notably, the diameter of the gelatin nanofibers is a function of the process used to obtain the gelatin nanofibers from gelatin. Herein, the weighted average diameter is calculated based on diameter of each of the gelatin nanofibers obtained. It will be appreciated that the diameter of the gelatin nanofibers may vary. Therefore, the weighted average diameter is calculated as an average of the product of different diameters of nanofibers obtained and number of each of the nanofibers of different diameters. The weighted average diameter of the gelatin nanofibers may be, for example, from 20 nm (nanometers), 30 nm, 40 nm, 50 nm, 60 nm, 70 nm, 80 nm, 90 nm, 0.1 μm (micrometers), 0.2 μm, 0.3 μm. 0.4 μm. 0.5 μm, 0.6 μm, 0.7 μm, 0.8 μm, 0.9 μm or 1 μm up to 50 nm, 60 nm, 70 nm, 80 nm, 90 nm, 0.1 μm, 0.2 μm, 0.3 μm. 0.4 μm. 0.5 μm, 0.6 μm, 0.7 μm, 0.8 μm, 0.9 μm, 1 μm, 1.5 μm or 2 μm.

The method comprises producing a nanofibrous material using the produced gelatin nanofibers. The gelatin nanofibers are bonded to form the nanofibrous material. Notably, techniques such as mechanical bonding, chemical bonding, thermal bonding or a combination thereof may be employed to produce the nanofibrous material from the gelatin nanofibers. For instance, in mechanical bonding, physical entanglement of the nanofibers is performed to produce the nanofibrous material. It will be appreciated that due to high hydrophilicity of the gelatin nanofibers and presence of empty spaces (namely, voids) between the nanofibers, the nanofibrous material has high moisture-retention properties. Therefore, such empty spaces between the nanofibers are either partially or completely filled subsequently to improve water-resistant properties of the nanofibrous material.

The method comprises treating the nanofibrous material by a crosslinking agent for forming adhesion bonds in the nanofibrous material and to obtain the nanofibrous non-woven material. The singular gelatin nanofibers have high tensile strength and elastic modulus. However, the nanofibrous material obtained using such gelatin nanofibers has poor mechanical properties due to weak interactions between the nanofibers. Therefore, interaction and adhesion between the fibers needs to be improved to enhance the mechanical properties of nanofibrous material. Herein, the term “crosslinking agent” refers to a process or a chemical compound that improves adhesion between the gelatin nanofibers of the nanofibrous material. Notably, in order to improve the adhesion between the gelatin nanofibers, the crosslinking agent enhances interaction by forming adhesion bonds between the gelatin nanofibers using a process or may provide the chemical compound that may interlink the gelatin nanofibers with each other. Furthermore, by improving the adhesion between the gelatin nanofibers, the crosslinking agent enables to fill interfibrous voids in the nanofibrous non-woven material. Beneficially, water-resistant properties of the nanofibrous non-woven material are significantly improved by the crosslinking agent as the interfibrous voids act as capillaries and absorb water by capillary action. More specifically, forming adhesion bonds in the nanofibrous material enables to enhance interactions between the gelatin fibers and to improve fibers adhesion to each other to improve mechanical properties of the non-woven nanofibrous material. Further, forming the bonds enables to fill voids between the fibers in the non-woven nanofibrous material and thus to reduce water absorption caused by the empty spaces between the fibers. The empty space between the fibers act as capillaries and therefore absorb water due to capillary forces. Therefore, by filing the empty spaces by crosslinking reactions it enables to block the capillary forces.

Optionally, treating by the crosslinking agent comprises treating by a first physical crosslinking agent selected from a physical stimuli group comprising electron beam irradiation, plasma treatment, thermal treatment for forming covalent adhesion bonds between the gelatin nanofibers in the nanofibrous non-woven material. Notably, the first physical crosslinking agent forms covalent adhesion bonds amongst the gelatin nanofibers in the nanofibrous non-woven material. The electronic beam irradiation enables free radical formation in the nanofibrous non-woven material, wherein two free radicals induced by irradiation combine to form a covalent bond, thereby improving adhesion between the gelatin nanofibers. Similarly, plasma treatment induces crosslinking between the gelatin nanofibers and improves structural and morphological stability of the nanofibrous non-woven material. In thermal treatment, the nanofibrous material is heated at controlled temperatures for predefined time periods to obtain desired crosslinking between the gelatin nanofibers. Beneficially, the physical stimuli enable improvement of mechanical properties of nanofibrous non-woven material using a simplified and efficient process.

Optionally, treating by the crosslinking agent comprises incorporating a second physical crosslinking agent selected from a polymer group comprising polymers polyethylene, polypropylene, polysiloxane, polyurethane, polyvinyl alcohol, polyvinyl acetate, polyethylene glycol, polyamide, or any co-polymer including at least one of the polymers into the nanofibrous non-woven material for forming adhesion bonds between the second physical crosslinking agent and the gelatin nanofibers in the nanofibrous non-woven material by dispersion, dipole-dipole forces, dipole induced dipole forces or hydrogen bonding. Herein, the second physical crosslinking agent does not form covalent bonds with the gelatin nanofibers and bonds with the gelatin nanofibers by other interactions such as dispersion, dipole-dipole forces, dipole induced dipole forces or hydrogen bonding. Such intermolecular forces between functional groups of the gelatin nanofibers and the second physical crosslinking agent allow binding of the polymer with the gelatin nanofibers in the nanofibrous non-woven material. Notably, the type of polymers for second physical crosslinking agent is selected based on types of properties desired from the nanofibrous non-woven material. It will be appreciated that the polar functional groups of the gelatin nanofibers are masked using the second physical crosslinking agent in order to improve water-resistant properties of the nanofibrous non-woven material.

Optionally, treating by the crosslinking agent comprises carrying out a chemical crosslinking reaction with a chemical crosslinking agent selected from a group of monomeric or polymeric compounds having two or more reactive functional groups for forming covalent adhesion bonds between the chemical crosslinking agent and gelatin nanofibers in the nanofibrous non-woven material, wherein the group of monomeric or polymeric compounds comprises amino (—NH2), hydroxyl (—OH), thiol (—SH), aldehyde (—CHO), ketone (—C═O), isocyanate (—NCO), isothiocyanate (—NCS), isocyanide (—NC), halide (—Cl, —Br, —I), epoxide, aziridine, vinyl (—CH═CH2), carbodiimide (—N═C═N—), alkali metals (—M, where M is Li, Na, K), hydride (-H), carboxylic acid derivatives, wherein the chemical crosslinking reaction is carried out in temperature —80° C.-250° C. and pressure 0 bar-100 bar. Herein, the two or more reactive functional groups of the monomeric or polymeric compounds react with the functional groups of gelatin nanofibers, for example, hydroxyl (—OH), carboxyl (—COOH), amino (—NH2), amide (—CONH2). Notably, the chemical crosslinking agent enables polymerization of the nanofibrous non-woven material and crosslinks the gelatin nanofibers. In an instance, when the two or more reactive functions groups are carboxylic acid derivatives i.e. —COX, the X is an activating group such as a halogen (for example, F, —Cl, —Br, —I), vinyl (—CH═CH2), N-hydroxysuccinimidyl, 1-hydroxybenzotriazolyl or any other group, of which corresponding acid HX has water-phase pKa value lower than 14. Furthermore, the chemical crosslinking reaction may be carried out at temperature, for example, from —80°, 70°, 60°, 50°, 40°, 30°, 20°, 10°, 0°, 10°, 20°, 30°, 40°, 50°, 60°, 70°, 80°, 90°, 100°, 110°, 120°, 130°, 140°, 150°, 160°, 170°, 180°, 190°, 200°, 210°, 220° or 230° Celsius (C) up to −60°, 50°, −40°, 30°, 20°, 10°, 0°, 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230°, 240° or 250° C. The chemical crosslinking reaction may be carried out at pressure, for example, from 0, 10, 20, 30, 40, 50, 60, 70, 80 or 90 bar up to 10, 20, 30, 40, 50, 60, 70, 80, 90 or 100 bar. Additionally, optionally, the chemical crosslinking reaction is carried out in presence of at least one of: a chemical catalyst, a polymerization initiator or an additional reagent, such as a base or an acid, a physical modifier such as UV-light or microwave radiation.

In an embodiment, carrying out the chemical crosslinking reaction with the chemical crosslinking agent comprises treating the nanofibrous non-woven material in a treatment solution, wherein the treatment solution comprises vinyl-terminated polydimethylsiloxane (vt-PDMS), hydroxy-terminated polydimethylsiloxane (ht-PDMS) or a combination thereof and poly(dimethylsiloxane-comethylhydrosiloxane) (co-PMHS) as the chemical crosslinking agent, wherein viscosity of the chemical crosslinking agent is 1 cSt -500000 cSt, concentration of the chemical crosslinking agent in the treatment solution is 0.001%-50%, hydride substitution ratio in co-PDMS is 0.2%-100%; and drying the treated nanofibrous non-woven material at a drying temperature 0° C.-250° C. for a time period 1 second-48 hours. Herein, the nanofibrous non-woven material is treated with the chemical crosslinking agent, wherein the gelatin nanofibers are polymerized with polysiloxane in the time period the nanofibrous non-woven material is dried. In particular, treating the nanofibrous non-woven material may comprise one or more processes such as immersing, coating, applying, spraying the nanofibrous non-woven material with the chemical crosslinking agent or the solution or mixture comprising the crosslinking agent. Furthermore, the drying temperature and time period are selected based on specific composition of the treatment solution used for treating the nanofibrous non-woven material. The drying temperature may be, for example, from 0°, 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230° or 240° C. up to 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230°, 240° or 250° C. Moreover, the time period for drying may be, for example, from 1, 5, 10, 20, 30, 60 seconds, 2, 5, 10, 15, 30, 45, 60 minutes, 2, 3, 4, 5, 10, 15, 20, 25, 30, 35, 40 or 45 hours up to 5, 10, 20, 30, 60 seconds, 2, 5, 10, 15, 30, 45, 60 minutes, 2, 3, 4, 5, 10, 15, 20, 25, 30, 35, 40, 45 or 48 hours.

Optionally, the viscosity of the chemical crosslinking agent is 1-500000 centistokes (cSt). The viscosity of the chemical crosslinking agent may be, for example, from 1, 2, 3, 4, 5, 6, 7, 8, 9, 10, 50, 100, 200, 300, 400, 500, 1000, 5000, 10000, 15000, 20000, 50000, 75000, 100000, 150000, 200000, 250000, 300000, 350000 or 400000 cSt up to 2, 3, 4, 5, 6, 7, 8, 9, 10, 50, 100, 200, 300, 400, 500, 1000, 5000, 10000, 15000, 20000, 50000, 75000, 100000, 150000, 200000, 250000, 300000, 350000, 400000, 450000 or 500000 cSt. For example, in an embodiment, hydrides having the viscosity 2-3 cSt may be used. Furthermore, the concentration of the chemical crosslinking agent in the treatment solution may be for example, from 0.001, 0.002, 0.003, 0.004, 0.005, 0.01, 0.05, 0.1, 0.5, 1, 2, 3, 5, 10, 15, 20, 25, 30, 35, 40 or 45% up to 0.002, 0.003, 0.004, 0.005, 0.01, 0.05, 0.1, 0.5, 1, 2, 3, 5, 10, 15, 20, 25, 30, 35, 40, 45 or 50%. The hydride substitution ratio in poly(dimethylsiloxane-comethylhydrosiloxane) may be, for example, from 0.2, 0.3, 0.4, 0.5, 1, 2, 3, 5, 10, 15, 20, 25, 30, 35, 40, 45, 50, 55, 60, 65, 70, 75, 80, 85, 90 or 95% up to 0.3, 0.4, 0.5, 1, 2, 3, 5, 10, 15, 20, 25, 30, 35, 40, 45, 50, 55, 60, 65, 70, 75, 80, 85, 90, 95 or 100%.

Optionally, the treatment solution further comprises a catalyst and a solvent. In particular, the catalyst is a platinum-based catalyst or a rhodium-based catalyst that is capable of catalyzing vinyl-hydride addition reaction or de-hydrosilylation reaction. The concentration of the catalyst in the treatment solution is 0.001 ppm-1000 ppm (parts per million). For example, the concentration of the catalyst in the treatment solution may be from 0.001, 0.002, 0.003, 0.004, 0.005, 0.01, 0.05, 0.1, 1, 5, 10, 50, 100, 200, 300, 400, 500, 750 or 900 ppm up to 0.002, 0.003, 0.004, 0.005, 0.01, 0.05, 0.1, 1, 5, 10, 50, 100, 200, 300, 400, 500, 750, 900 or 1000 ppm. Moreover, the solvent used in the treatment solution is of low polarity. Examples of the solvent include, but are not limited to, isomers of pentane, hexane, heptane and octane, cyclohexane, benzene, toluene, isomers of xylene, tetra-chlorocarbon, chloroform, dichloromethane, diethyl ether, methyl-t-butylether or mixtures thereof. Additionally, optionally, the treatment solution comprises a filler. Examples of filler include, but are not limited to, hydrophilic or hydrophobic silica particles, diatomaceous earth, calcium carbonate, carbon black, montmorillonite or other clays. The concentration of filler in the treatment solution may be up to 75%.

In another embodiment, carrying out the chemical crosslinking reaction with the chemical crosslinking agent comprises treating the nanofibrous non-woven material in a treatment solution, wherein the treatment solution comprises hydroxyl-terminated polydimethylsiloxane (ht-PDMS) and a chemical compound capable of reacting with hydroxyl groups of ht-PDMS as the chemical crosslinking agent, wherein viscosity of the chemical crosslinking agent is 0.1 cSt-500000 cSt or the chemical crosslinking agent is in solid form and concentration of the chemical crosslinking agent in the treatment solution is 0.001%-99%; and drying the treated nanofibrous non-woven material at a drying temperature 0° C.-250° C. for a time period 1 second to 120 hours. Herein, the nanofibrous non-woven material is treated with the chemical crosslinking agent, wherein the gelatin nanofibers are polymerized with polysiloxane in the time period the nanofibrous non-woven material is dried. The chemical compound capable of reacting with hydroxyl groups of ht-PDMS may have a general structure of R1Si(OCOR2)₃, R1Si(OR2)₃, Si(OR1)₄, wherein R1 and R2 represent alkyl substituents or may be di-t-butoxydiacetoxysilane, bis-(triethoxysilyl)ethane, methyltris-(methylethylketoximino)silane, vinyltris-(methylethylketoximino) silane, vinyltriisopropenoxysilane, bis(N-methylbenzamido) ethoxymethylsilane, tris(cyclohexylamino)methylsilane. Furthermore, the drying temperature and time period are selected based on specific composition of the treatment solution used for treating the nanofibrous non-woven material. The drying temperature may be, for example, from 0°, 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230° or 240° C. up to 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230°, 240° or 250° C. Moreover, the time period for drying may be, for example, from 1, 5, 10, 20, 30, 60 seconds, 2, 5, 10, 15, 30, 45, 60 minutes, 2, 3, 4, 5, 10, 15, 20, 25, 30, 35, 40, 45, 50, 60, 70, 80, 90, 100 or 110 hours up to 5, 10, 20, 30, 60 seconds, 2, 5, 10, 15, 30, 45, 60 minutes, 2, 3, 4, 5, 10, 15, 20, 25, 30, 35, 40, 45, 50, 60, 70, 80, 90, 100, 110 or 120 hours.

Optionally, the viscosity of the chemical crosslinking agent is 0.1-500000 cSt. The viscosity of the chemical crosslinking agent may be, for example, from 0.1, 0.2, 0.3, 0.4, 0.5, 0.6, 0.7, 0.8, 0.9, 1, 2, 3, 4, 5, 6, 7, 8, 9, 10, 50, 100, 200, 300, 400, 500, 1000, 5000, 10000, 15000, 20000, 50000, 75000, 100000, 150000, 200000, 250000, 300000, 350000 or 400000 cSt up to 0.2, 0.3, 0.4, 0.5, 0.6, 0.7, 0.8, 0.9, 1, 2, 3, 4, 5, 6, 7, 8, 9, 10, 50, 100, 200, 300, 400, 500, 1000, 5000, 10000, 15000, 20000, 50000, 75000, 100000, 150000, 200000, 250000, 300000, 350000, 400000, 450000 or 500000 cSt. For example, in an embodiment condensation cure silicone crosslinkers which are low molecular weight liquid and less viscous than water can be used. Alternatively, the chemical crosslinking agent is in solid form. Moreover, the concentration of the chemical crosslinking agent in the treatment solution may be for example, from 0.001, 0.002, 0.003, 0.004, 0.005, 0.01, 0.05, 0.1, 0.5, 1, 2, 3, 5, 10, 15, 20, 25, 30, 35, 40, 45, 50, 55, 60, 65, 70, 75, 80, 85, 90 or 95% up to 0.002, 0.003, 0.004, 0.005, 0.01, 0.05, 0.1, 0.5, 1, 2, 3, 5, 10, 15, 20, 25, 30, 35, 40, 45, 50, 55, 60, 65, 70, 75, 80, 85, 90, 95 or 99%. The concentration of chemical compound capable of reacting with hydroxyl groups of ht-PDMS in the treatment solution is 0.001% to 20%. In an example, the concentration of the chemical compound may be, for example, from 0.001, 0.002, 0.003, 0.004, 0.005, 0.01, 0.05, 0.1, 0.5, 1, 2, 3, 5, 10 or 15% up to 0.002, 0.003, 0.004, 0.005, 0.01, 0.05, 0.1, 0.5, 1, 2, 3, 5, 10, 15 or 20%.

Optionally, the treatment solution further comprises a solvent. Notably, the solvent may be of a low polarity. Examples of the solvent include, but are not limited to, isomers of pentane, hexane, heptane and octane, cyclohexane, benzene, toluene, isomers of xylene, tetra-chlorocarbon, chloroform, dichloromethane, diethyl ether, methyl-t-butylether or mixtures thereof. Additionally, optionally, the treatment solution comprises a catalyst. In particular, the catalyst is a tin-based catalyst or a titanium-based catalyst used to accelerate crosslinking reaction. The concentration of the catalyst in the treatment solution may be up to 5%. Optionally, the treatment solution comprises a filler. Examples of filler include, but are not limited to, hydrophilic or hydrophobic silica particles, diatomaceous earth, calcium carbonate, carbon black, montmorillonite or other clays. The concentration of filler in the treatment solution may be up to 75%.

In yet another embodiment, carrying out the chemical crosslinking reaction with the chemical crosslinking agent comprises treating the nanofibrous non-woven material with a natural oil mixture, wherein the natural oil mixture comprises at least one natural oil of a olive oil, rapeseed oil, hemp oil, castor oil, linseed oil, soybean oil, corn oil, cottonseed oil, palm oil, safflower oil, sunflower oil or any mixture of said oils as the chemical crosslinking agent, wherein concentration of the natural oil in the natural oil mixture is 0.1%-100%; and drying the treated nanofibrous non-woven material at a drying temperature 40° C.-250° C. for a time period 1 hour to 120 hours for carrying out radical polymerization between carbon-carbon double bonds present in the natural oil mixture; forming a polymeric material between gelatin nanofibers. Herein, the one or more natural oils in natural oil mixture are triglycerides containing at least one carbon-carbon double bond in side-chains thereof. Notably, the treated nanofibrous non-woven material is dried at an elevated drying temperature (i.e., 40° C.-250° C.) to carry out the radical polymerization between carbon-carbon double bonds present in the natural oil mixture, thereby forming the polymeric material between gelatin nanofibers. In particular, the gelatin nanofibers are polymerized with biopolymers. The drying temperature may be, for example, from 40°, 50°, 60°, 70°, 80°, 90°, 100°, 110°, 120°, 130°, 140°, 150°, 160°, 170°, 180°, 190°, 200°, 210°, 220°, 230° or 240° C. up to 50°, 60°, 70°, 80°, 90°, 100°, 110°, 120°, 130°, 140°, 150°, 160°, 170°, 180°, 190°, 200°, 210°, 220°, 230°, 240° or 250° C. Moreover, the time period for drying may be, for example, from 1, 2, 3, 4, 5, 10, 15, 20, 25, 30, 35, 40, 45, 50, 60, 70, 80, 90, 100 or 110 hours up to 2, 3, 4, 5, 10, 15, 20, 25, 30, 35, 40, 45, 50, 60, 70, 80, 90, 100, 110 or 120 hours.

Optionally, the concentration of the natural oil in the natural oil mixture may be, for example, from 0.1, 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 60, 70, 80 or 90% up to 0.2, 0.3, 0.4, 0.5, 0.6, 0.7, 0.8, 0.9, 1, 2, 3, 4, 5, 6, 7, 8, 9, 10, 15, 20, 25, 30, 35, 40, 45, 50, 60, 70, 80, 90 or 100%.

Optionally, the natural oil mixture further comprises a solvent of low to medium polarity. Examples of the solvent include, but are not limited to, isomers of pentane, hexane, heptane and octane, cyclohexane, benzene, toluene, isomers of xylene, tetra-chlorocarbon, chloroform, dichloromethane, diethyl ether, methyl-t-butylether, ethyl acetate, acetone, tetrahydrofuran, isopropyl alcohol or mixtures thereof. Optionally, the natural oil mixture comprises a radical polymerization initiator. The concentration of the radical polymerization initiator may be up to 5%. The radical polymerization initiator may be selected from a group comprising azobisisobutyronitrile (AIBN), 1,1′-Azobis(cyclohexanecarbonitrile) (ABCN), benzoyl peroxide, di-tert-butylperoxide. Additionally, optionally, the treatment solution comprises additives. The additives may include plasticizers such as dibutylphthalate, dioctylphthalate, triethyl citrate, tributyl citrate, lecithin, colophonium, and fillers such as hydrophilic or hydrophobic silica particles, diatomaceous earth, calcium carbonate, carbon black, montmorillonite or other clays. The concentration of the additives in the natural oil mixture may be up to 5%.

In an exemplary implementation, the nanofibrous non-woven material is a bio-based, fully biodegradable material produced using non-woven material treated with natural oil mixture comprising linseed oil. Such material may be employed to bind atmospheric pollution, with an efficiency of up to 18 times the weight of the material. Gelatin itself cannot bind the oil, but by coating the gelatin fibers with linseed oil, it makes the material oleophilic, while retaining the fibrous structure in which the oil is stored. Furthermore, the fiber content in the treated nanofibrous non-woven material is 70-90% by weight and processing percentage (i.e., content of linseed oil and optionally, solvents) is 10-30%. In particular, best results for the treated nanofibrous non-woven material are obtained when the fiber content is 70-80% by weight and the processing percentage is 20-30%. In an embodiment, to achieve better oil adsorption, the nanofibrous non-woven material by weight and processing percentage is 80-90% and the processing percentage is 10-20%.

In yet another embodiment, carrying out the chemical crosslinking reaction with the chemical crosslinking agent comprises treating the nanofibrous non-woven material in a polyurethane forming mixture, wherein the polyurethane forming mixture comprises polyol and polyisocyanate as the chemical crosslinking agent, wherein molar mass of each of the polyol and polyisocyanate is 50-1000000, concentration of the chemical crosslinking agent in the mixture is 0.01%-75%; and drying the treated nanofibrous non-woven material at a drying temperature 0° C.-250° C. for a time period 1 second to 48 hours. Notably, the polyols and polyisocyanates in the polyurethane forming mixture react with each other to form a urethane bond. Alternatively, urea bonds may be formed when polyisocyanate is partially hydrolyzed to amine, which then reacts with unhydrolyzed isocyanate group. The polyol has at least two hydroxyl (—OH) groups and its main chain structure may be aliphatic or aromatic. Similarly, the polyisocyanate has at least two isocyanate (—NCO) groups and its main chain structure may be aliphatic or aromatic. The drying temperature may be, for example, from 0°, 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230° or 240° C. up to 10°, 20°, 30°, 40°, 50°, 60°, 70°, 80°, 90°, 100°, 110°, 120°, 130°, 140°, 150°, 160°, 170°, 180°, 190°, 200°, 210°, 220°, 230°, 240° or 250° C. Moreover, the time period for drying may be, for example, from 1, 5, 10, 20, 30, 60 seconds, 2, 5, 10, 15, 30, 45, 60 minutes, 2, 3, 4, 5, 10, 15, 20, 25, 30, 35, 40 or 45 hours up to 5, 10, 20, 30, 60 seconds, 2, 5, 10, 15, 30, 45, 60 minutes, 2, 3, 4, 5, 10, 15, 20, 25, 30, 35, 40, 45 or 48 hours.

Optionally, the molar mass of the each of the polyol and polyisocyanate may be, for example, from 50, 60, 70, 80, 90, 100, 200, 300, 400, 500, 1000, 5000, 10000, 15000, 20000, 50000, 75000, 100000, 150000, 200000, 300000, 400000, 500000, 600000, 700000, 800000 or 900000 up to 60, 70, 80, 90, 100, 200, 300, 400, 500, 1000, 5000, 10000, 15000, 20000, 50000, 75000, 100000, 150000, 200000, 300000, 400000, 500000, 600000, 700000, 800000, 900000 or 1000000. Furthermore, the concentration of the chemical crosslinking agent in the mixture may be, for example, from 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 15, 20, 25, 30,35, 40, 45, 50, 55, 60, 65 or 70% up to 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 15, 20, 25, 30,35, 40, 45, 50, 55, 60, 65, 70 or 75%.

Optionally, the polyurethane forming mixture further comprises a catalyst and a solvent. In particular, the catalyst is tertiary amines and tin or bismuth compounds. The concentration of the catalyst in the treatment solution is 0.001%-5%. For example, the concentration of the catalyst in the treatment solution may be from 0.001, 0.002, 0.003, 0.004, 0.005, 0.01, 0.05, 0.1, 1.0, 1.5, 2.0, 2.5, 3.0, 3.5, 4.0 or 4.5% up to 0.002, 0.003, 0.004, 0.005, 0.01, 0.05, 0.1, 1.0, 1.5, 2.0, 2.5, 3.0, 3.5, 4.0, 4.5 or 5%. Examples of the solvent include, but are not limited to, ethyl alcohol, methyl alcohol, isopropyl alcohol, water, ethyl acetate, chloroform, dichloromethane, diethyl ether, tetrahydrofuran, methyl-t-butylether, acetone or mixtures thereof. The concentration of the solvent in the polyurethane forming mixture may be up to 99.99%.

It will be appreciated that after treatment with the chemical crosslinking agent, strength of nanofibrous non-woven material increases ten-fold in comparison with untreated gelatin-based fibrous material. Notably, tensile strengths of the nanofibrous non-woven material is substantially dependent on the method used to produce gelatin nanofibers. Beneficially, the treatment of nanofibrous non-woven material with the crosslinking agent further improves environmental resistance of the material and other characteristics such as water resistance, abrasion resistance, softness. Furthermore, the polar functional groups of the gelatin nanofibers are masked using the chemical crosslinking agent in order to improve water-resistant properties of the nanofibrous non-woven material.

Optionally, the method further comprises laminating at least one layer of the nanofibrous non-woven material with at least one layer of a reinforcing material, wherein the reinforcing material is at least one of wood, plywood, plastic, ceramics, cotton, cotton gauze. In the embodiments the nanofibrous non-woven material further comprises at least one layer of reinforcing material as lamination. In some embodiments, the present disclosure teaches that laminated material comprising of material described above (e.g. nanofibrous material comprising gelatin nanofibers that can be cross-linked which interfibrous voids are partially filled with polymeric material like polysiloxane, filled with polymeric material like polymer derived from natural oil polymerization, filled with polymeric material like polyurethane) and the substrate that can be wood, cotton. Herein, reinforcing material is a stronger material and lamination is carried to achieve required final strength and improved mechanical properties of the nanofibrous non-woven material. Notably, the reinforcing material may be selected from at least one of a rigid or non-rigid surfaces such as wood, plywood, plastic, ceramics, cotton, cotton gauze, based on aesthetic and visual requirements or based on intended application of the material. The lamination of the nanofibrous non-woven material may be carried using methods such as thermal treatment, pressure treatment, adhesive layer application, needle punching or a combination thereof. The thermal treatment may comprise heat treatment of the nanofibrous non-woven material at a temperature of 20° C.-200° C. Furthermore, adhesive used for laminating the at least one layer of the nanofibrous non-woven material with at least one layer of a reinforcing material may include adhesives such as hot-melt glue, natural latex, polyurethane based adhesives, thermo-reactive adhesives and so forth. The at least one layer of reinforcing material may be glued to one side of the nanofibrous non-woven material or both side of the nanofibrous non-woven material.

In different further embodiment the nanofibrous non-woven material comprising at least one layer of reinforcing material as lamination may in addition comprise one or more additional layers of nanofibrous non-woven material. In such embodiments the at least one layer of reinforcing material may be glued between two layers of the nanofibrous non-woven material. In other embodiments the at least one layer of reinforcing material and two or more nanofibrous non-woven material may be glued in turn, wherein between each two layers of nanofibrous non-woven material there is one or more layers of reinforcing materials.

The thickness of the nanofibrous non-woven material comprising at least one layer of reinforcing material as lamination range from 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.5, 6.0, 6.5, 7.0, 7.5, 8.0, 8.5, 9.0, 9.5 or 10 mm up to 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.3, 6.9, 7.2, 7.5, 7.8, 8.1, 8.4, 8.7, 9.0, 9.3, 9.6, 9.9 or 10.2 mm, which is suitable for the wide range of applications and products according to the claim 15. Depending on the number of reinforcing material layers and the number of the nanofibrous non-woven material layers the better properties can be achieved. E.g. Laminated material comprising three non-woven material layers laminated with 4 cotton gauge reinforcing material layers enables to provide end material having thickness 2-4 mm which is suitable for the wide range of applications and products according to the claim 15.

The at least one layer of reinforcing material layer may be at an angle of 0-90° with respect to the nanofibrous non-woven material layer. In an example layer of reinforcing material layer may be at an angle 0 or 45°, or in another example, wherein the nanofibrous non-woven material comprises more than one reinforcing material layers then at least one reinforcing material layer may be at an angle 0 and at least one reinforcing material layer may be at an angle 45°. Using the reinforcing material layers at different angles enables to improve further the mechanical properties of the nanofibrous non-woven material.

The present disclosure also relates to the nanofibrous non-woven material as described above. Various embodiments and variants disclosed above, with respect to the aforementioned first aspect, apply mutatis mutandis to the nanofibrous non-woven material.

Optionally, the nanofibrous non-woven material comprises the gelatin nanofibers treated by a first physical crosslinking agent selected from a physical stimuli group comprising electron beam irradiation, plasma treatment, thermal treatment; or a second physical crosslinking agent incorporated into the nanofibrous non-woven material and selected from a polymer group comprising polymers polyethylene, polypropylene, polysiloxane, polyurethane, polyvinyl alcohol, polyvinyl acetate, polyethylene glycol, polyamide, or any co-polymer including at least one of the polymers. This enables to form new covalent bonds between gelatin fibers which is helps to improve the adhesion between the gelatin fibers of nanofibrous non-woven material and thus improve the mechanical properties of the nanofibrous non-woven material.

Optionally, the nanofibrous non-woven material comprises the gelatin-nanofibers treated by a chemical crosslinking agent selected from a group of monomeric or polymeric compounds having two or more reactive functional groups, wherein the group of monomeric or polymeric compounds comprises amino (—NH2), hydroxyl (—OH), thiol (—SH) aldehyde (—CHO), ketone (—C═O), isocyanate (—NCO), isothiocyanate (—NCS), isocyanide (—NC), halide (—Cl, —Br, —I), epoxide, aziridine, vinyl (—CH═CH₂), carbodiimide (—N═C═N—), alkali metals (-M, where M is Li, Na, K), hydride (—H), carboxylic acid derivatives. In the compounds of carboxylic acid derivatives (—COX), the X is activating group such as halogen (—F, —Cl, —Br, —I), vinyl (—CH═CH2), N-hydroxysuccinimidyl, 1-hydroxybenzotriazolyl or any other group, which corresponding acid HX, has water-phase pKa value lower than 14. These compounds are able to react with functional groups found in gelatin, e.g. hydroxyl (—OH), carboxyl (—COOH), amino (—NH2), amide (—CONH2) and thus help to improve the adhesion between the gelatin fibers of nanofibrous non-woven material and improve the mechanical properties of the nanofibrous non-woven material Upon chemical crosslinking reaction, new covalent bonds form between the crosslinker and two different gelatin fibers. Chemical crosslinking reaction can be carried out in various conditions: temperature −80 . . . 250° C., pressure 0 . . . 100 bar, with the presence or absence of chemical catalyst, initiator or additional reagent (such as a base or acid) and with presence or absence of physical modifier (such as UV-light or microwave irradiation).

The present disclosure provides a material comprising a nanofibrous non-woven material produced by using the method for producing a nanofibrous non-woven material for making a non-woven leather-like material for textile, fashion, interior design, automotive, packaging applications; biomaterial for dentistry, wound-care, cell cultivation applications; air filtration products. Notably, the material comprising a nanofibrous non-woven material provides an eco-friendly textile alternative for fashion or interior design purposes with a texture similar to suede or leather. Furthermore, the material may be used as a three-dimensional scaffolding for cell cultivation, for example, for growing liver cells than can be used for cancer drug testing. Moreover, the material may be used as a biomaterial for dentistry to support bone regrowth after tooth extraction.

### EXAMPLES

Nanofibrous gelatin-based material can be treated by previously mentioned crosslinking techniques to improve mechanical properties of the material. Hereby, different crosslinking techniques are described.

1. Treatment with Two-Component Polysiloxane Mixture

Nanofibrous gelatin-based material is immersed in a solution containing the following components: vinyl- or hydroxy-terminated polydimethylsiloxane (vt-PDMS or ht-PDMS correspondingly) or their combination in any ratio, poly(dimethylsiloxane-co-methylhydrosiloxane) (co-PMHS), platinum or rhodium-based catalyst, solvent and a filler (optional). Viscosities of vt-PDMS, ht-PDMS and co-PDMS can vary from 5-500000 cSt and their concentration in treatment solution can vary from 0.001%-50%. Hydride substitution ratio in co-PDMS can vary from 0.2-100%. Any Pt-based or Rh-based catalyst, which is capable of catalyzing vinyl-hydride addition reaction or dehydrosilylation reaction can be used with concentration range of 0.001-1000 ppm. Solvents with low polarity can be used, such as isomers of pentane, hexane, heptane and octane, cyclohexane, benzene, toluene, isomers of xylene, tetrachlorocarbon, chloroform, dichloromethane, diethyl ether, methyl-t-butylether, or their mixtures. Optional fillers include hydrophilic or hydrophobic silica particles, diatomaceous earth, calcium carbonate, carbon black, montmorillonite or other clays which concentration can vary from 0% to 75%. After immersion in treatment solution the nanofibrous gelatin-based material is dried during which polymerization occurs. Drying temperatures can vary from 0-250° C., and the drying time can vary from 1 second to 48 hours depending on the exact composition of treatment solution used.

2. Treatment with Condensation-Cure Polysiloxane Mixture

Nanofibrous gelatin-based material is immersed in a solution containing the following components: hydroxyl-terminated polydimethylsiloxane (ht-PDMS), crosslinker capable reacting with hydroxyl groups of ht-PDMS, solvent, optional catalyst and optional filler. Viscosity of ht-PDMS can vary from 5-500000 cSt and its concentration can vary from 0.001%-99%. Crosslinker can be any chemical compound capable of reacting with two hydroxyl groups of ht-PDMS. For example, they can have general structures R1Si(OCOR2)3, R1Si(OR2)3, Si(OR1)4, where R1 and R2 represent alkyl substituents or can be di-t-butoxydiacetoxysilane, bis(triethoxysilyl)ethane, methyltris(methylethylketoximino)silane, vinyltris(methylethylketoximino)silane, vinyltriisopropenoxysilane, bis(N-methylbenzamido) ethoxymethylsilane, tris(cyclohexylamino) methylsilane. Crosslinker concentration can vary from 0.001%-20%. Solvents with low polarity can be used, such as isomers of pentane, hexane, heptane and octane, cyclohexane, benzene, toluene, isomers of xylene, tetrachlorocarbon, chloroform, dichloromethane, diethyl ether, methyl-t-butylether, or their mixtures. Optionally, a tin- or titanium-based catalyst can be added to accelerate reaction with concentration of 0-5%. Optional fillers include hydrophilic or hydrophobic silica particles, diatomaceous earth, calcium carbonate, carbon black, montmorillonite or other clays which concentration can vary from 0% to 75%. After immersion in treatment solution the material is dried during which polymerization occurs. Drying temperatures can vary from 0-250° C., and the drying time can vary from 1 second to 120 hours depending on the exact composition of treatment solution used. For example, when using catalyst, the treatment time can be reduced from 4 h to 15 min when using silanes in the treatment mixtures.

3. Treatment with Natural Oils

Nanofibrous gelatin-based material is treated with a mixture containing natural oils, optional solvent, optional initiator and optional additives. Natural oil can be any triglyceride containing at least one carbon-carbon double bond in their side-chains, such as olive, rapeseed, hemp, castor, linseed, soybean, corn, cottonseed, palm, safflower, sunflower oil or any mixture of oils. Their total content in treatment mixture can vary from 0.1-100%. Solvents with low to medium polarity can be used, such as isomers of pentane, hexane, heptane and octane, cyclohexane, benzene, toluene, isomers of xylene, tetrachlorocarbon, chloroform, dichloromethane, diethyl ether, methyl-t-butylether, ethyl acetate, acetone, tetrahydrofuran, isopropyl alcohol or their mixtures. Radical polymerization initiator can be added to mixture, such as azobisisobutyronitrile (AIBN), 1,1′-Azobis(cyclohexanecarbonitrile) (ABCN), benzoyl peroxide, di-tert-butylperoxide, with a concentration from 0-5%. Optional additives include plasticizers such as dibutylphthalate, dioctylphthalate, triethyl citrate, tributyl citrate, lecithin, colophonium and fillers such as hydrophilic or hydrophobic silica particles, diatomaceous earth, calcium carbonate, carbon black, montmorillonite or other clays. Concentration of additives can vary from 0-75%. After treating the material with natural oil mixture, the product is dried 1-120 hours at elevated temperature (40-250° C.) to carry out radical polymerization between carbon-carbon double bonds present in natural oils, forming a polymeric material between gelatin fibres.

4. Treatment with Two-Component Polyurethane Forming Mixture

Nanofibrous gelatin-based material is treated with polyurethane forming mixture. Mixture consists of polyols and polyisocyanates that react with each other to form a urethane bond. Alternatively, urea bonds may be formed, when polyisocyanate is partially hydrolyzed to amine, which then reacts with unhydrolysed isocyanate group. The polyol has at least two hydroxyl (—OH) groups and its main chain structure can be aliphatic or aromatic. Polyol molar mass can range from 50 to 1000000 and its content in mixture can vary from 0.01%-75%. The polyisocyanate has at least two isocyanate (—NCO) groups and its main chain structure can be aliphatic or aromatic. Polyisocyanate molar mass can range from 50 to 1000000 and its content in mixture can vary from 0.01%-75%. Additionally, the mixture can include catalysts such as tertiary amines and tin or bismuth compounds with concentrations 0.001%-5%. Mixture can be diluted with different solvents like ethyl alcohol, methyl alcohol, isopropyl alcohol, water, ethyl acetate, chloroform, dichloromethane, diethyl ether, tetrahydrofuran, methyl-t-butylether, acetone or other solvents or their mixtures. Solvent content can vary from 0%-99.99%. After immersion of nanofibrous gelatin-based material to treatment mixture, the material is dried for a time range of 1 s . . . 48 h at a temperature between 0-250° C. After treatment there is a ten-fold tensile strength increase compared to untreated gelatine-based fibrous material. Tensile strengths of the base and end material depend greatly on the method used to produce gelatin nanofibers. Treatment also improves environmental resistance of the material and other characteristics such as water resistance, abrasion resistance, softness.

### Lamination

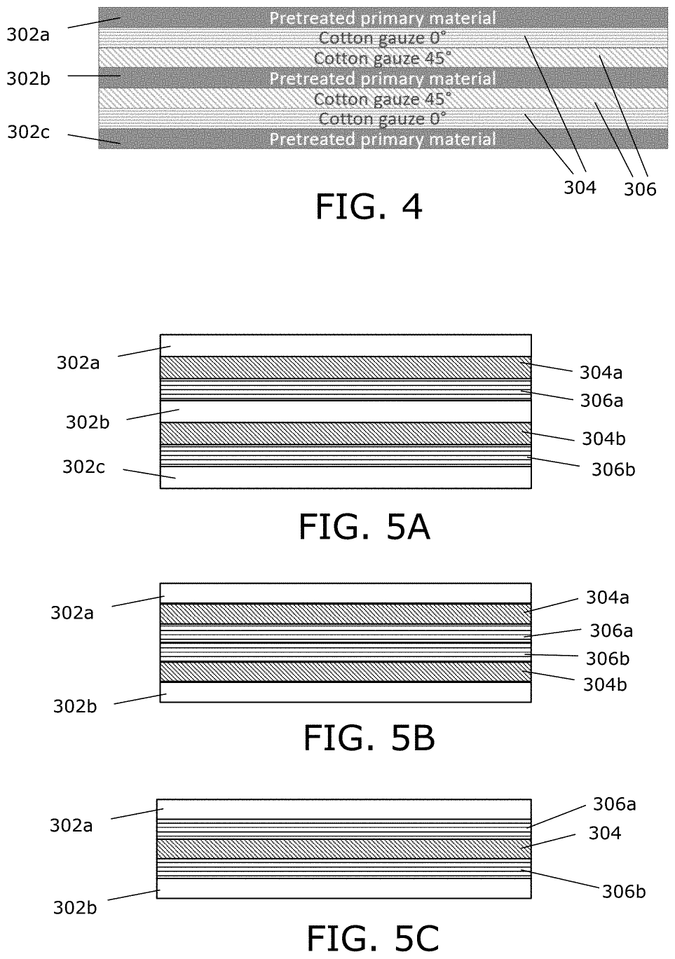

Two layers of described material are laminated between a layer of reinforcing material as illustrated in figures FIG. 4 and FIG. 5A-FIG. 5B. This is achieved with heat (20-200° C.), pressure, adhesive layer, needle punching or combination of said methods. Material is laminated on rigid surface (wood, plywood, plastic, ceramics) for decorative purposes. This is achieved with heat (20-200° C.), pressure, adhesive layer, needle punching or combination of said methods. Lamination is carried out to enhance end materials mechanical properties. In that case material described above acts as a visual/decorative layer as substrate will determine mechanical properties of the end material.

### Example of Products

The present disclosure is focused on making eco-friendly textile for fashion or interior design that compared to other materials is now the most similar to suede or leather. Also, the nanofibrous mesh that is created with the described process can be used also in various other applications, such as: (1) 3 d scaffold for cell cultivation (for instance for growing liver cells on it that can then be used for cancer drug testing); (2) biomaterial for dentistry to help the bone to re-grow after tooth extraction; (3) wound-care; (4) air filtration.

The embodiments of the leather-like material according to the present disclosure have been tested in textile applications and accessories of the leather-like material have been produced. Different measurements to determine physical properties of the leather-like material have been carried out. For example following tests have been carried out: Tear Strength (ISO 13937-2:2000)—4.02 to 6.60 N; Tensile Strength (EN ISO 13934-1:2013) 99.78 to 590 N; Abrasion/Martindale test (ISO 12947-1:2001 and ISO 12947-4:2001)—up to 50 000 cycles. More detailed examples of the tests results are described in the table as follows.

| TESTED | | | DIFFERENT SAMPLES RESULTS | | |
|---|---|---|---|---|---|
| PROPERTY | TEST METHOD | Unit | treatment A | treatment B | treatment C |
| Tear Strength | ISO 13937-2: 2000 | Mean Peak | 6.60 | 4.02 | 5.3 |
| | | Force (N) | | | |
| Tensile | EN ISO | Force at | 99.78 | 287.11 | 590 |
| Strength | 13934-1: 2013 | Rupture (N) | | | |
| Elongation | EN ISO | Elongation | 7.53 | 9.48 | 11 |
| | 13934-1: 2013 | at Rupture | | | |
| | | (%) | | | |
| Abrasion/ | ISO 12947-1: 2001; | number of | 5000 | 1000 cycles leaves | one sample: NO |
| Martindale | ISO 12947-4: 2001 | cycles and | cycles and | major mark, 3000 | change in 50000 |
| | 9 kPa pressure load; | visual look | no change | cycles breaks the | cycles; most |
| | temperature 22.0° C.; | | | surface totally | samples surface |
| | air humidity 31% | | | | slightly damaged |
| | | | | | and some fibers out |
| | | | | | at 5000 cycles |
| Flexing | | | | no test done but by | no official test but |
| endurance | | | | hand has cracks | by hand does not |
| | | | | after ca 25 cycles | change after over |
| | | | | | 150 cycles |
| Colour fastness | ISO 105-X12: 2016 | 5 score | | dry: 2; wet 2/3 | dry: 4/5; |
| to rubbing | (Temperature 22° C.; | evaluation (5 - | | | wet 4 |
| cycles ©- | Air humidity 31%); | no change) | | | |
| change in | dry and wet | | | | |
| colour and | | | | | |
| staining* | | | | | |
| Colour fastness | ISO 105-C06: 2010. | 5 score | | wool - 5; | wool - 5; |
| to washing | The test was | evaluation (5 - | | acryl- 5; | acryl- 5; |
| | performed at 40° C. | no change) | | polyester - 5; | polyester-4/5; |
| | Duration of washing | | | polyamid - 5; | polyamid-4/5; |
| | cycle 30 min. 10 steel | | | cotton - 5; | cotton-4/5; |
| | balls in the washing | | | acetate - 5 | acetate - 4 |
| | container. 150 ml of | | | | |
| | washing solution | | | | |
| Colour fastness | ISO 105-E04; both | 5 score | | Alkaline vs acidic: | |
| to perspiration | alkaline and acidic | evaluation (5 - | | wool-4/5vs 3/4 | |
| | tests were conducted | no change) | | acryl- 4/5 vs 4 | |
| | and colour fastness | | | polyester- | |
| | where tested with | | | (4)/5vs(4)/5 | |
| | different textiles to | | | polyamid-4vs3 | |
| | see whether colour | | | cotton-4/5vs4 | |
| | passes on those | | | acetate-4vs3/4 | |
| | textiles. | | | | |
| Determination | ISO 4920: 2012 | 5 score | | 0-1 (material | 0-1 (material |
| of resistance to | Temp.: 22° C.; Air | evaluation (5 - | | surface gets wet, | surface gets wet, |
| surface wetting | humidity 35%; Water | no change) | | but water does not | but water does not |
| (spray test) | temperature 26.0° C.; | | | go through the | go through the |
| | Amount of water s | | | material) | material) |
| | 250 ml | | | | |
| Static Air | Instrument: FX 3300 | l/m2/s | | Average: 9.12 l/m2/s; | Averages (l/m2/2): |
| Permeability | LabAir IV. Serial No.: | | | Minimum: 2.59 l/m2/s; | sample 1 - 11.6 |
| | 720. | | | Maximum: 18.0 l/m2/s; | sample 2 - 14.9 |
| | Settings | | | CV: 46.4% | sample 3 - 10.7 |
| | Test pressure: 100 Pa | | | | sample 4 - 11.9 |
| | Test area: 20 cm2 | | | | sample 5 - 5.28 |
| | Nom/Min/Max: −1.00/ | | | | |
| | −1.00/−1.00 l/m2/s | | | | |
| Resistance by | Standard EN ISO | ignites or | | Ignition of 10 sec; | Out of 8 samples 2 |
| ignition to | 6940: 2004 | not | | 3 out of 8 ignites, 5 | ignite after ignition |
| match | | | | don't. In ignition of | of 11 seconds. |
| | | | | 15 sec probability | |
| | | | | is much bigger. | |

An example material according to the present disclosure consists of biopolymer nanofibers that are bonded with adhesive and finally laminated with reinforcing layer. Polymer fibers are in diameter ranging from 20 nm to 2 μm that are treated with adhesive to enhance materials tensile strength, abrasion resistance and resistance to environment.

### DETAILED DESCRIPTION OF THE DRAWINGS

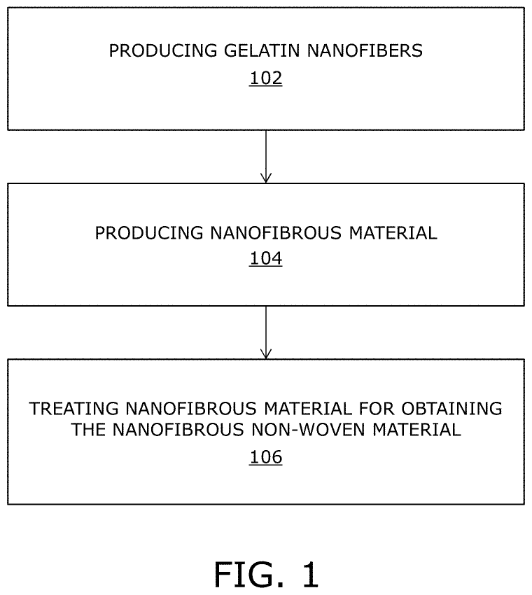

Referring to FIG. 1, there is shown a flow chart depicting steps of a method for producing a nanofibrous non-woven material, in accordance with an embodiment of the present disclosure, wherein the method comprises producing gelatin nanofibers at step 102, producing a nanofibrous material using the produced gelatin nanofibers at step 104, treating the nanofibrous material by a crosslinking agent for forming adhesion bonds in the nanofibrous material and to obtain the nanofibrous non-woven material 106. The steps 102, 104 and 106 are only illustrative and other alternatives can also be provided where one or more steps are added, one or more steps are removed, or one or more steps are provided in a different sequence without departing from the scope of the claims herein.

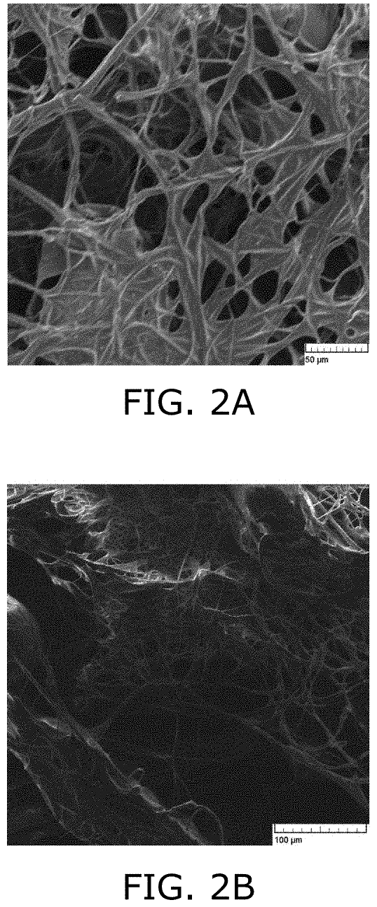

Referring to figures FIG. 2A and FIG. 2B, there are shown scanning electron microscope (SEM) images of the nanofibrous non-woven material, in accordance with an embodiment of the present disclosure and showing gelatin fibers covered by silicone treating. FIG. 2A illustrates the gelatin fibers covered by silicone treating of the nanofibrous non-woven material with respect to a scale of 50 μm, whereas FIG. 2B illustrates the gelatin fibers covered by silicone treating of the nanofibrous non-woven material with respect to a scale of 100 μm. Notably, in FIGS. 2A and 2B crosslinking is observed between the gelatin nanofibers in the nanofibrous non-woven material.

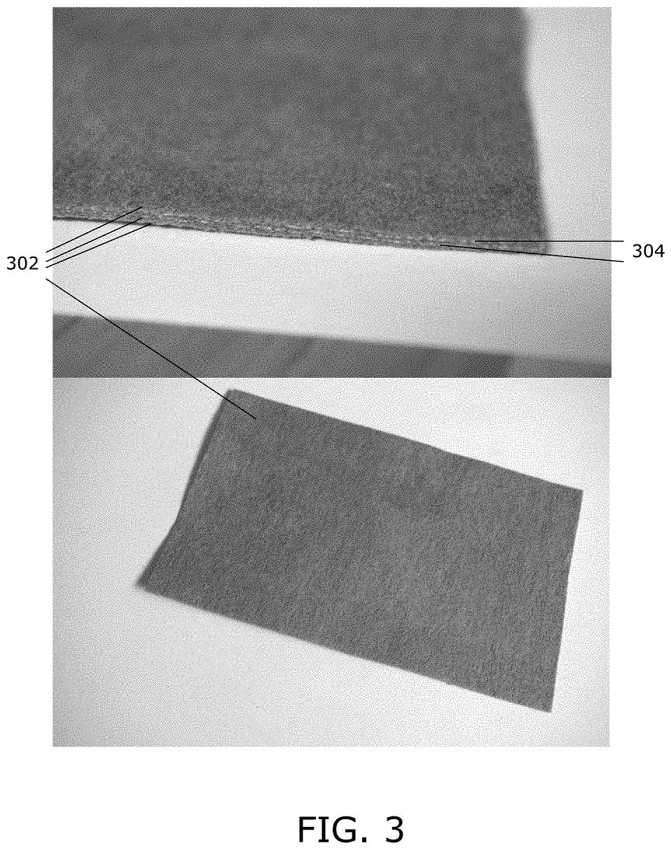

Referring to FIG. 3 there is shown an example of laminated nanofibrous non-woven material according to an embodiment of the preset disclosure, wherein the laminated nanofibrous non-woven material having nanofibrous non-woven material layers 302 (i.e. darker layers) and reinforcing material layers 304, 306 (i.e. lighter layers).

Referring to FIG. 4 there is shown an example of laminated nanofibrous non-woven material according to an embodiment of the present disclosure illustrating a bidirectionally oriented material layers used to reinforce the nanofibrous non-woven material, wherein the laminated nanofibrous non-woven material comprises a first nanofibrous non-woven material layer of pretreated primary material 302a, a second nanofibrous non-woven material layer of pretreated primary material 302b, a third nanofibrous non-woven material layer of pretreated primary material 302c, a first layer of reinforcing material 304 and a second layer of reinforcing material 306. According to the embodiment the first layer of reinforcing material 304 and the second layer of reinforcing material 306 form the bidirectionally oriented material layers comprising both cotton gauze, wherein orientation of the first layer of reinforcing material 304 is aligned at an angle of 0° and orientation of the second layer of reinforcing material 306 is aligned at an angle of 45°.Referring to figures FIG. 5A, FIG. 5B and FIG. 5C, there are shown schematic illustrations of laminated nanofibrous non-woven materials, in accordance with various implementations of the present disclosure, comprising at least one nanofibrous non-woven material layer 302 and one or more lamination layers for reinforcing the material.

In FIG. 5A there is illustrated an example of laminated nanofibrous non-woven material according to an embodiment of the present disclosure comprising a first nanofibrous non-woven material layer 302a, a second nanofibrous non-woven material layer 302b, a first layer of reinforcing material 304a and a second layer of reinforcing material 306a glued between the first nanofibrous non-woven material layer 302a and the second nanofibrous non-woven material layer 302b, wherein the first layer of reinforcing material 304a is at an angle of 45° with respect to the first nanofibrous non-woven material layer 302a and the second layer of reinforcing material 306a, and the second nanofibrous non-woven material layer 306a is at an angle of 0° with respect to the first nanofibrous non-woven material layer 302a and the first layer of reinforcing material 304a, and wherein laminated nanofibrous non-woven material further comprises a third nanofibrous non-woven material layer 302c, third layer of reinforcing material 304b and a fourth layer of reinforcing material 306b glued between the second nanofibrous non-woven material layer 302b and the third nanofibrous non-woven material layer 302c and wherein the third layer of reinforcing material 304b is at an angle of 45° with respect to the second nanofibrous non-woven material layer 302b and the fourth layer of reinforcing material 306b, and the fourth layer of reinforcing material 306b is at an angle of 0° with respect to the third nanofibrous non-woven material layer 302c and the third layer of reinforcing material 304b.

In FIG. 5B there is illustrated an example of laminated nanofibrous non-woven material according to an embodiment of the present disclosure comprising a first nanofibrous non-woven material layer 302a, a second nanofibrous non-woven material layer 302b, and a first layer of reinforcing material 304a, a second layer of reinforcing material 306a, a third layer of reinforcing material 306b and a fourth layer of reinforcing material 304b glued between the first nanofibrous non-woven material layer 302a and the second nanofibrous non-woven material layer 302b, wherein the first layer of reinforcing material 304a and the fourth layer of reinforcing material 304b are correspondingly at an angle of 45° with respect to the first nanofibrous non-woven material layer 302a and the second nanofibrous non-woven material layer 304b, and the second layer of reinforcing material 306a and third layer of reinforcing material 306b between the first and fourth layers of reinforcing material 304a, 304b are at an angle of 0° with respect to the first and fourth layers of reinforcing material 304a, 304b.

In FIG. 5C there is illustrated an example of laminated nanofibrous non-woven material according to an embodiment of the disclosure comprising a first nanofibrous non-woven material layer 302a, a second nanofibrous non-woven material layer 302b, and a first layer of reinforcing material 304, a second layer of reinforcing material 306a, a third layer of reinforcing material 306b glued alternately between the first nanofibrous non-woven material layer 302a and the second nanofibrous non-woven material layer 302b, wherein the second layer of reinforcing material 306a and the third layer of reinforcing material 306b are correspondingly at an angle of 0° with respect to the first nanofibrous non-woven material layer 302a and the second nanofibrous non-woven material layer 304b, and the first layer of reinforcing material 304 is an angle of 45° with respect to the second layer of reinforcing material 306a and the third layer of reinforcing material 306b.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for producing a nanofibrous non-woven material, the method comprising
producing gelatin nanofibers;
producing a nanofibrous material using the produced gelatin nanofibers; and
treating the nanofibrous material by a crosslinking agent for forming adhesion bonds in the nanofibrous material and to obtain the nanofibrous non-woven material.

2. The method according to claim 1, wherein treating by the crosslinking agent comprises treating by a first physical crosslinking agent selected from a physical stimuli group comprising electron beam irradiation, plasma treatment, thermal treatment for forming covalent adhesion bonds between the gelatin nanofibers in the nanofibrous non-woven material.

3. The method according to claim 1, wherein treating by the crosslinking agent comprises incorporating a second physical crosslinking agent selected from a polymer group comprising polymers polyethylene, polypropylene, polysiloxane, polyurethane, polyvinyl alcohol, polyvinyl acetate, polyethylene glycol, polyamide, or any co-polymer including at least one of the polymers into the nanofibrous non-woven material for forming adhesion bonds between the second physical crosslinking agent and the gelatin nanofibers in the nanofibrous non-woven material by dispersion, dipole-dipole forces, dipole induced dipole forces or hydrogen bonding.

4. The method according to claim 1, wherein treating by the crosslinking agent comprises carrying out a chemical crosslinking reaction with a chemical crosslinking agent selected from a group of monomeric or polymeric compounds having two or more reactive functional groups for forming covalent adhesion bonds between the chemical crosslinking agent and gelatin nanofibers in the nanofibrous non-woven material, wherein the group of monomeric or polymeric compounds comprises amino (—NH2), hydroxyl (—OH), thiol (—SH) aldehyde (—CHO), ketone (—C═O), isocyanate (—NCO), isothiocyanate (—NCS), isocyanide (—NC), halide (—Cl, —Br, —I), epoxide, aziridine, vinyl (—CH═CH₂), carbodiimide (—N═C═N—), alkali metals (-M, where M is Li, Na, K), hydride (-H), carboxylic acid derivatives, wherein the chemical crosslinking reaction is carried out in temperature −80° C.-250° C. and pressure 0 bar-100 bar.

5. The method according to claim 4, wherein carrying out the chemical crosslinking reaction with the chemical crosslinking agent comprises:
treating the nanofibrous non-woven material in a treatment solution, wherein the treatment solution comprises vinyl-terminated polydimethylsiloxane (vt-PDMS), hydroxy-terminated polydimethylsiloxane (ht-PDMS) or a combination thereof and poly(dimethylsiloxane-comethylhydrosiloxane) (co-PMHS) as the chemical crosslinking agent, wherein viscosity of the chemical crosslinking agent is 1 cSt-500000 cSt, concentration of the chemical crosslinking agent in the treatment solution is 0.001%-50%, hydride substitution ratio in co-PDMS is 0.2%-100%; and
drying the treated nanofibrous non-woven material at a drying temperature 0° C.-250° C. for a time period 1 second-48 hours.

6. The method according to claim 4, wherein carrying out the chemical crosslinking reaction with the chemical crosslinking agent comprises:
treating the nanofibrous non-woven material in a treatment solution, wherein the treatment solution comprises hydroxyl-terminated polydimethylsiloxane (ht-PDMS) and a chemical compound capable of reacting with hydroxyl groups of ht-PDMS as the chemical crosslinking agent, wherein viscosity of the chemical crosslinking agent is 0.1 cSt-500000 cSt or the chemical crosslinking agent is in solid form and concentration of the chemical crosslinking agent in the treatment solution is 0.001%-99%; and
drying the treated nanofibrous non-woven material at a drying temperature 0° C.-250° C. for a time period 1 second to 120 hours.

7. The method according to claim 4, wherein carrying out the chemical crosslinking reaction with the chemical crosslinking agent comprises:
treating the nanofibrous non-woven material with a natural oil mixture, wherein the natural oil mixture comprises at least one natural oil of a olive oil, rapeseed oil, hemp oil, castor oil, linseed oil, soybean oil, corn oil, cottonseed oil, palm oil, safflower oil, sunflower oil or any mixture of said oils as the chemical crosslinking agent, wherein concentration of the natural oil in the natural oil mixture is 0.1%-100%; and
drying the treated nanofibrous non-woven material at a drying temperature 40° C.-250° C. for a time period 1 hour to 120 hours for carrying out radical polymerization between carbon-carbon double bonds present in the natural oil mixture;
forming a polymeric material between gelatin nanofibers.

8. The method according to claim 4, wherein carrying out the chemical crosslinking reaction with the chemical crosslinking agent comprises:
treating the nanofibrous non-woven material in a polyurethane forming mixture, wherein the polyurethane forming mixture comprises polyol and polyisocyanate as the chemical crosslinking agent, wherein molar mass of each of the polyol and polyisocyanate is 50-1000000, concentration of the chemical crosslinking agent in the mixture is 0.01%-75%; and
drying the treated nanofibrous non-woven material at a drying temperature 0° C.-250° C. for a time period 1 second to 48 hours.

9. The method according to claim 1, wherein the method further comprises laminating at least one layer of the nanofibrous non-woven material with at least one layer of a reinforcing material, wherein the reinforcing material is at least one of wood, plywood, plastic, ceramics, cotton, cotton gauze.

10. A nanofibrous non-woven material comprising cross-linked gelatin nanofibers.

11. The nanofibrous non-woven material according to claim 10, wherein the nanofibrous non-woven material comprises the gelatin nanofibers treated by
a first physical crosslinking agent selected from a physical stimuli group comprising electron beam irradiation, plasma treatment, thermal treatment; or
a second physical crosslinking agent incorporated into the nanofibrous non-woven material and selected from a polymer group comprising polymers polyethylene, polypropylene, polysiloxane, polyurethane, polyvinyl alcohol, polyvinyl acetate, polyethylene glycol, polyamide, or any co-polymer including at least one of the polymers.

12. The nanofibrous non-woven material of claim 10, wherein the nanofibrous non-woven material comprises the gelatin-nanofibers treated by a chemical crosslinking agent selected from a group of monomeric or polymeric compounds having two or more reactive functional groups, wherein the group of monomeric or polymeric compounds comprises amino (—NH2), hydroxyl (—OH), thiol (—SH) aldehyde (—CHO), ketone (—C═O), isocyanate (—NCO), isothiocyanate (—NCS), isocyanide (—NC), halide (—Cl, —Br, —I), epoxide, aziridine, vinyl (—CH═CH₂), carbodiimide (—N═C═N—), alkali metals (-M, where M is Li, Na, K), hydride (—H), carboxylic acid derivatives.

13. The nanofibrous non-woven material according to claim 1, wherein a weighted average diameter of the gelatin nanofibers is 20 nm-2 μm.

14. The nanofibrous non-woven material of any of claim 10, wherein the nanofibrous non-woven material further comprises at least one layer of reinforcing material as lamination.

15. A material comprising a nanofibrous non-woven material produced by using a method according to claim 1 for making a non-woven leather-like material for textile, fashion, interior design, automotive, packaging applications; biomaterial for dentistry, wound-care, cell cultivation applications; air filtration products.

16. A nanofibrous material comprising gelatin nanofibers that can be cross-linked which interfibrous voids are partially filled with polymeric material like polysiloxane, with polymeric material like polymer derived from natural oil polymerization or with polymeric material like polyurethane.

17. A laminated material comprising of material according to claim 16 and the substrate that can be wood, cotton.
